(19) United States
(12) Patent Application Publication
(10) Pub. No.: US 2026/0331664 A1
(43) Pub. Date: Oct. 22, 2026

(54) BATTERY PACK

(71) Applicant: MILWAUKEE ELECTRIC TOOL CORPORATION, Brookfield, WI (US)

(72) Inventors: James D. Lorenz, Wauwatosa, WI (US); Calvin C. Brice, Wauwatosa, WI (US); David Hernandez, JR., Waukesha, WI (US); Changhyuk Kim, Wauwatosa, WI (US); Jan N. Maroske, Brookfield, WI (US)

(21) Appl. No.: 19/651,070

(22) Filed: Apr. 17, 2026

Related U.S. Application Data
(60) Provisional application No. 63/790,459, filed on Apr. 17, 2025.

(51) Int. Cl. H01M 50/213; H01M 50/505

(52) U.S. Cl. CPC H01M 50/213; H01M 50/505; H01M 2220/30

(57) ABSTRACT

A battery pack may include a housing defining an internal cavity. A battery pack may include a cell frame disposed within the internal cavity and configured to support a plurality of battery cells, the cell frame including an exterior surface, a first stud, and a second stud extending from the exterior surface, the first stud having a first cross-sectional dimension and the second stud having a second cross-sectional dimension different from the first cross-sectional dimension. A battery pack may include a busbar disposed within the internal cavity and electrically coupled to the plurality of battery cells, the busbar defining a first bore and a second bore, wherein the first bore is configured to receive the first stud and the second bore is configured to receive the second stud.

### CROSS-REFERENCE

This application claims priority to U.S. Provisional Patent Application No. 63/790,459, filed Apr. 17, 2025, the entire content of which is incorporated herein by reference.

### FIELD

The present disclosure relates to battery packs including battery packs for power tools.

### BACKGROUND

In a battery pack, busbars are coupled to batteries housed within a cell frame. During assembly, the busbar may shift relative to the cell frame before being welded to the battery cells. Accordingly, it may be advantageous to secure the busbar to the cell frame during assembly.

### SUMMARY

In some aspects, the techniques described herein relate to a battery pack including: a housing including a first housing portion and a second housing portion, the first housing portion secured to the second housing portion and defining a cavity therebetween, and the first housing portion defining an interface configured to couple to a power tool; a cell frame supported within cavity of the housing, the cell frame including a plurality of openings to secure a plurality of battery cells, the openings defining an axis, a first stud extending perpendicular to the axis, the first stud having a first diameter, and a second stud extending perpendicular to the axis, the second stud having a second diameter greater than the first diameter; and a busbar disposed within the cavity of the housing, the busbar including a first bore configured to receive at least a portion of the first stud, and a second bore configured to receive at least a portion of the second stud.

In some aspects, the techniques described herein relate to a battery pack including: a housing defining an internal cavity and an interface configured to couple to a power tool; a cell frame disposed within the internal cavity and configured to support a plurality of battery cells, the cell frame including an external surface and a stud protruding from the external surface; a busbar disposed within the internal cavity and electrically coupled to the plurality of battery cells, the busbar defining a bore configured to receive the stud; and a printed circuit board disposed within the internal cavity and electrically coupled to the busbar; wherein the stud couples the busbar to the cell frame.

In some aspects, the techniques described herein relate to a battery pack including: a housing defining an internal cavity and an interface configured to couple to a power tool; a cell frame disposed within the internal cavity and configured to support a plurality of battery cells, the cell frame including an external surface and a stud protruding from the external surface; and a busbar disposed within the internal cavity and electrically coupled to the plurality of battery cells, the busbar defining a bore configured to receive the stud; wherein the stud includes a tapered portion configured to guide alignment of the stud into the bore.

Other aspects of the embodiments will become apparent by consideration of the detailed description and accompanying drawings.

### BRIEF DESCRIPTION OF THE DRAWINGS

FIG. 1 is a perspective view of a battery pack according to some constructions.

FIG. 2 is a side cross-sectional view taken from line 2-2 in FIG. 1, according to some constructions.

FIG. 3 is a perspective view of a cell frame of a battery pack of FIG. 1, according to some constructions.

FIG. 4 is a top view of the cell frame of FIG. 3 including a plurality of busbars, according to some construction.

FIG. 5 is a top view of a busbar of FIG. 4 including a bore according to some constructions.

FIG. 6 illustrates a plurality of exemplary bores according to some constructions.

FIG. 7 illustrates a plurality of exemplary studs according to some constructions.

FIG. 8A is an exemplary schematic of an interaction between a first exemplary stud and a first exemplary bore according to a first construction.

FIG. 8B is an exemplary schematic of an interaction between a second exemplary stud and a second exemplary bore according to a second construction.

FIG. 8C is an exemplary schematic of an interaction between a third exemplary stud and a third exemplary bore according to a third construction.

FIG. 9 is a schematic of a side view of an interface between a busbar and a stud according to some constructions.

### DETAILED DESCRIPTION

Before any independent constructions of the disclosure are explained in detail, it is to be understood that the disclosure is not limited in its application to the details of construction and the arrangement of components set forth in the following description or illustrated in the following drawings. The disclosure is capable of other independent constructions and of being practiced or of being carried out in various ways.

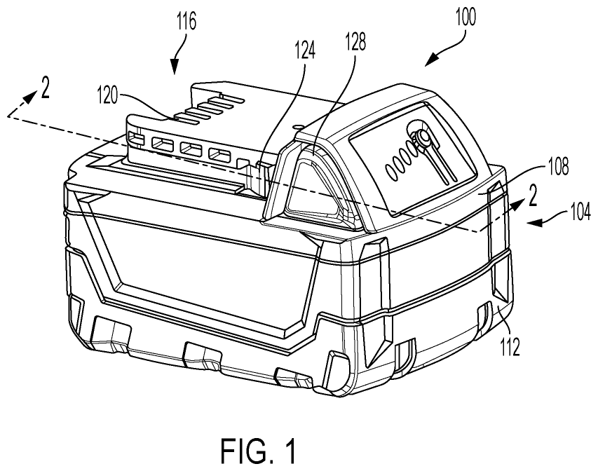

FIG. 1 illustrates a battery pack 100 including an outer housing 104 including a first housing member 108 and a second housing member 112. The first housing member 108 of the battery pack 100 includes a tool interface 116 that removably, mechanically, and electrically couples to a power tool (not shown) or another electric device. The tool interface 116 includes a plurality of terminals 120 and a latch 124. The latch 124 is coupled to a corresponding button 128 to operatively couple the tool interface 116 to a corresponding electric device. The second housing member 112 is coupled to the first housing member 108 via, e.g., a fastener (not shown) or another mechanical connection means (e.g., ultrasonic welding, adhesives, etc.). The outer housing 104 defines and encloses an internal cavity 132. Specifically, the internal cavity 132 is defined and enclosed by the first housing member 108 and the second housing member 112. In some embodiments, the internal cavity 132 can be sealed from the external environment by the outer housing 104.

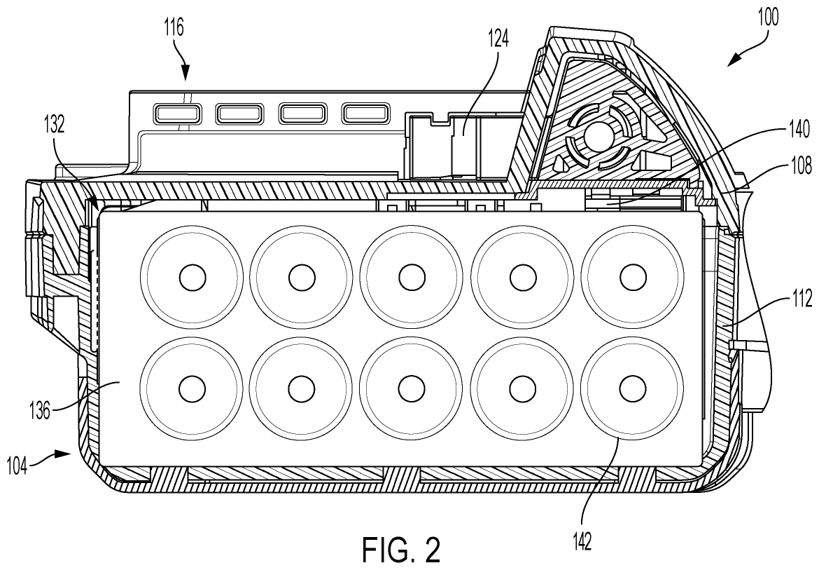

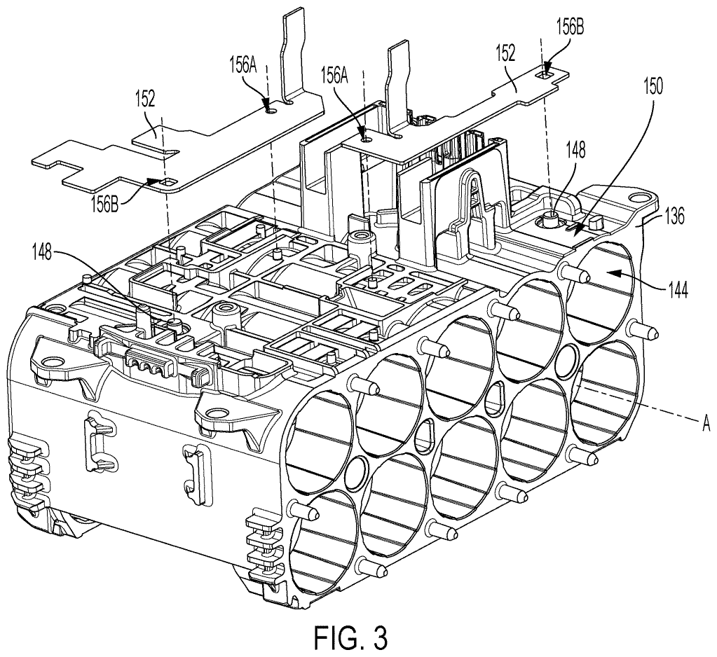

With reference to FIGS. 2-3, the battery pack 100 further includes a cell frame 136 and a printed circuit board 140 (PCB 140) supported within the internal cavity 132 of the outer housing 104. The PCB 140 is electrically coupled to the terminals 120 of the tool interface 116. The cell frame 136 defines a plurality of apertures 144 (FIG. 3) sized and spaced to house a plurality of battery cells 142. The battery cells 142 are held by the cell frame 136 within the apertures 144. In some constructions, the battery cells 142 are cylindrical in shape and define a cell can and opposite cell headers. In other constructions other types of battery cells (e.g., pouch cell, prismatic cell, etc.) may be implemented.

The cell frame 136 also defines one or more studs 148 protruding outward from an exterior surface 150 that faces away from the apertures 144. In some embodiments, the studs 148 include studs 148A, 148B extending from the exterior surface 150 in a direction that is perpendicular to an axis A extending centrally through one of the apertures 144. The axis A also extends centrally and longitudinally through the battery cell 142 supported within the aperture 144. The studs 148A, 148B may be integrally formed with the cell frame 136 as a single piece. In some embodiments, the cell frame 136 is formed from a resin material (e.g., plastic) and the studs 148 are integrally formed therewith as a single piece. In some constructions, the studs 148A, 148B may be oriented at another angle (e.g., parallel or transverse) relative to the axis A.

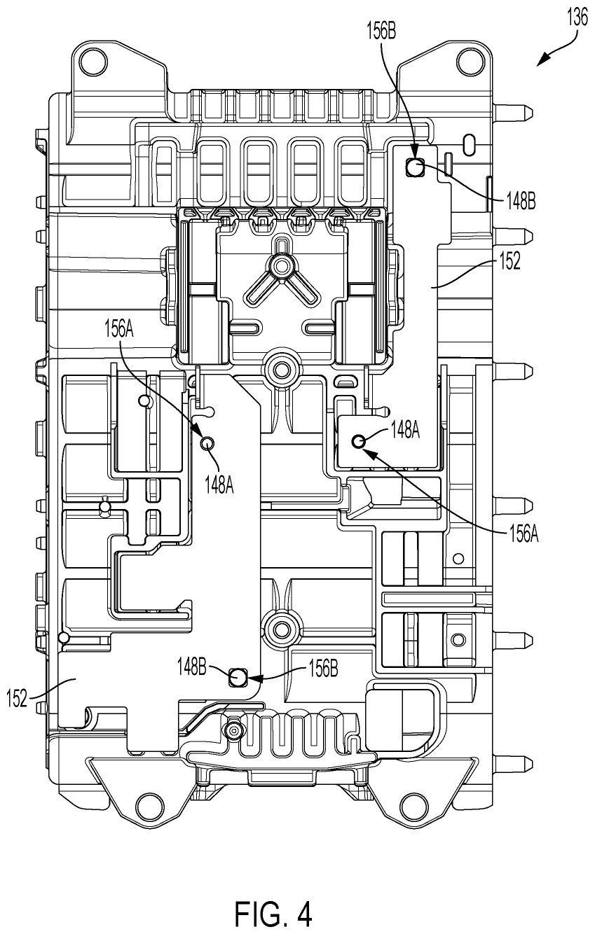

As shown in FIGS. 3-4, the battery pack 100 further includes busbars 152 disposed adjacent to or on the cell frame 136. The busbars 152 may be made of metal and may be electrically conductive. The busbars 152 electrically connect the battery cells 142 to one another and/or to the PCB 140. The busbars 152 may connect the battery cells 142 in series or parallel configurations or a combination thereof. The PCB 140 may control the power transferred between the battery cells 142 and the terminals 120 of the tool interface 116. In the illustrated construction each of the busbars 152 is integrally formed as a single piece. In other constructions, the busbars may be formed using a plurality of pieces coupled together. The busbars 152 define one or more bores 156 shaped to receive at least a portion of the one or more studs 148. In the illustrated embodiment, the one or more bores 156 include a first bore 156A sized and shaped to receive the stud 148A, and a second bore 156B sized and shaped to receive the stud 148B. The bores 156A, 156B may receive the studs 148A, 148B by a tolerance fit (e.g., a clearance fit, an interference fit, a transition fit, etc.). Accordingly, the studs 148A, 148B may couple the busbars 152 to the cell frame 136. The busbars 152 may be harder than the studs 148A, 148B such that the studs 148A, 148B may deform as they are inserted into the bores 156A, 156B to fit within the bores 156A, 156B. In some embodiments, the busbar 152 may include only a single bore 156 that receives a single stud 148.

In the illustrated construction, the studs 148A are received by the bores 156A and the studs 148B are received by the bores 156B. In other constructions, additional or fewer studs and bores may be incorporated for each busbar 152. Multiple attachment points between the cell frame 136 and the busbars 152 may prevent misalignment resulting from rotation between the cell frame 136 and the busbars 152. Multiple attachment points between the cell frame 136 and the busbars 152 may also reduce the relative vibration between the cell frame 136 and the busbars 152. In yet other constructions, the busbars 152 may include additional or fewer bores to allow for flexibility in the configuration of the busbars 152 when coupled to the cell frame 136.

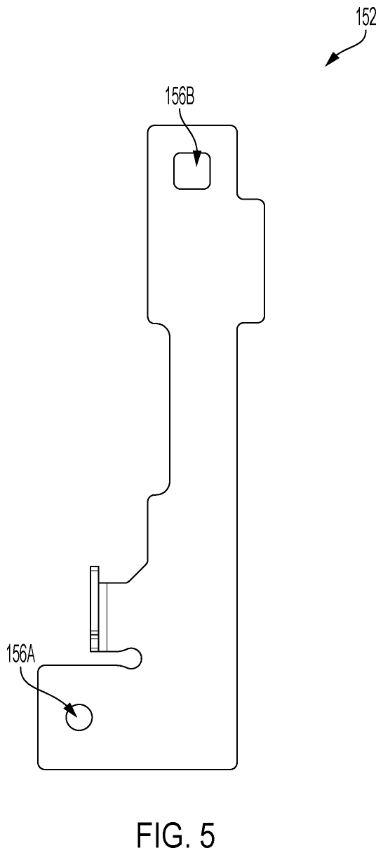

In the embodiment shown in FIGS. 3-5, the studs 148A, 148B are cylindrically shaped. The studs 148B are larger than the studs 148A. More specifically, the studs 148B define a first diameter that is larger than a second diameter defined by the studs 148A. The bore 156A is correspondingly cylindrical, or circular in cross-section, with a diameter similar to (e.g., +/−0.1 mm, +/−0.2 mm, +/−0.4 mm, etc.) the first diameter. In some embodiments, bore 156B is rectangular in cross-section and defines a length and a width. The length and the width of the bore 156B may be similar to (e.g., +/−0.1 mm, +/−0.2 mm, +/−0.4 mm, etc.) the second diameter of the stud 148B. Providing the stud 148B larger than the stud 148A simplifies manufacturing of the battery pack 100 by ensuring only one (correct) orientation of the busbar 152 relative to the cell frame 136. As discussed in further detail below, in other constructions the dimensions and geometries of both the studs 148A, 148B of the cell frame 136 and the bores 156A, 156B of the busbars 152 may vary. It will be appreciated that having attachment points of varied size, shape, and/or alignment limits the number of allowable configurations between the cell frame 136 and busbars 152 when coupled together, thereby simplifying the assembly of the battery pack 100.

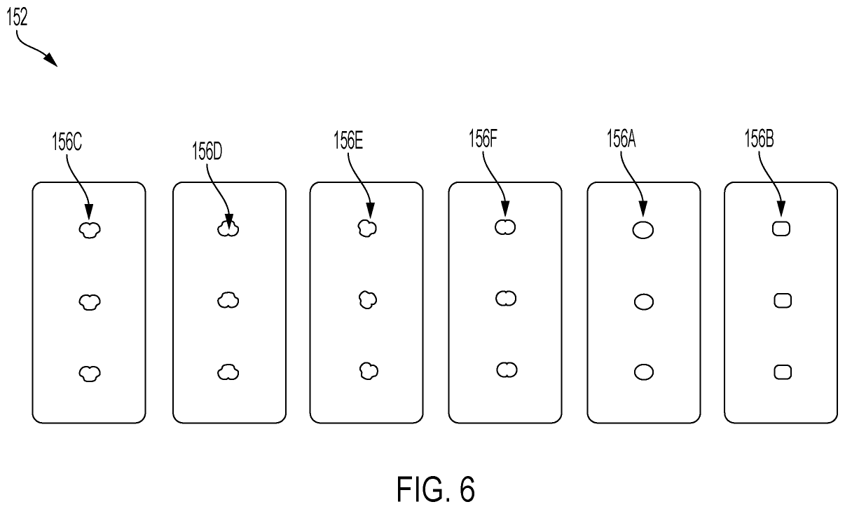

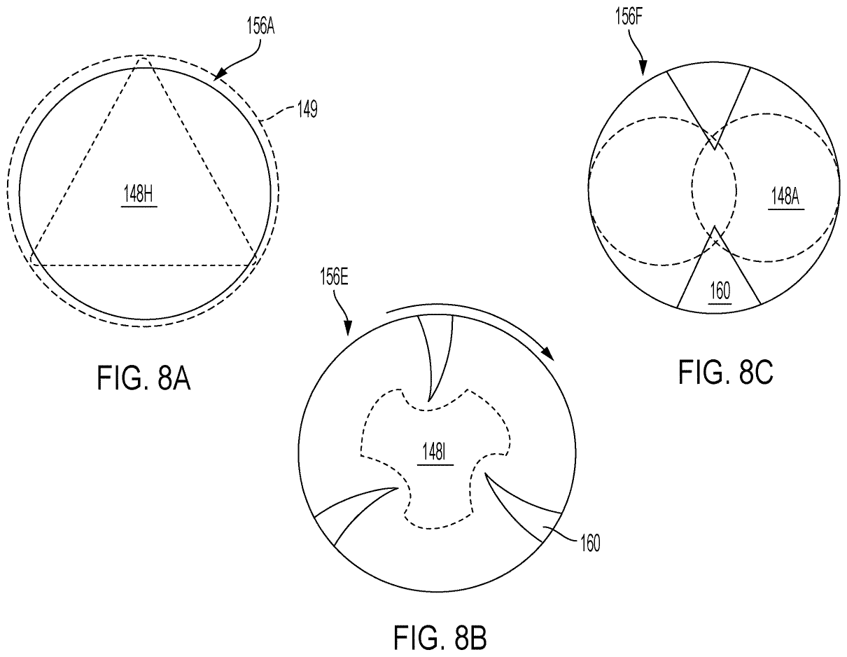

FIG. 6 illustrates a plurality of exemplary busbars 152 having bores 156C, 156D, 156E, 156F, 156G, 156H of varied geometry. Bores 156C. 156D, and 156E are clover shaped, and define an outer perimeter having an outer diameter and a plurality of protrusions 160 (FIGS. 8B and 8C) extending inward from the outer perimeter. The protrusions 160 define an inner diameter corresponding with the minimum diameter of a stud (e.g., stud 148A or stud 148B) configured to fit between the plurality of protrusions 160. The bore 156F is shaped substantially like two intersecting circles and defines an outer perimeter having at least one outer diameter and a plurality of protrusions extending inward from the outer perimeter defining an inner diameter.

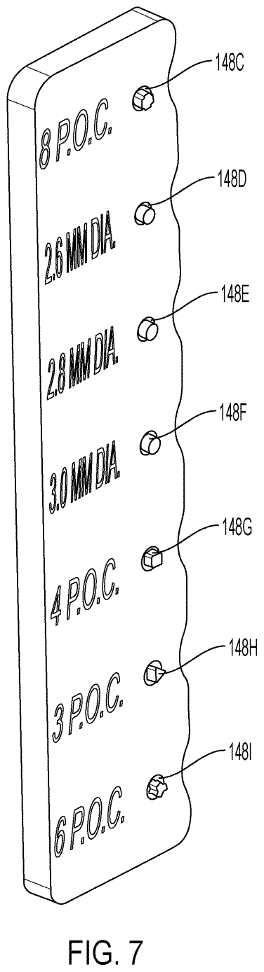

FIG. 7 illustrates a plurality of exemplary studs 148C, 148D, 148E, 148F, 148G, 148H, 148I. The studs 148D, 148E, 148F are similar to the studs 148A and 148B, being cylindrically shaped and having a diameter. In the illustrated construction, the stud 148D has a diameter of 2.6 mm, the stud 148E has a diameter of 2.8 mm, and the stud 148F has a diameter of 3.0 mm. In other constructions, other stud diameters may be incorporated. The studs 148C, 148G, 148H, and 148I are shaped to create a specific amount of “points of contact” between the stud and a circular bore of a busbar. In the illustrated construction, the edges of the studs 148C, 148G, 148H, and 148I are chamfered or filleted. The stud 148C has a cross-sectional shape of a cross and forms 8 points of contact. The stud 148G has a square cross-sectional shape and forms 4 points of contact. The stud 148H has a triangle cross-sectional shape and forms 3 points of contact. As described in further detail below, the stud 148I defines an inner diameter and an outer diameter and forms 6 points of contact.

It will be appreciated that simple shapes (e.g., circles, squares, triangles, etc.) may be easier to form and control during manufacturing, may be simpler geometries to measure (from a metrology standpoint), and may produce less wear on tooling during manufacturing.

FIGS. 8A-8C illustrate schematics of different interactions between different bores and studs. Specifically, FIG. 8A illustrates an interference fit between a triangular stud 148H and a circular bore 156A. As the circumscribed diameter 149 of the equilateral triangle of the stud 148H is greater than the diameter of the circular bore 156A, one or more portions (such as the points of contact) of the stud 148H may deform when received within the bore 156A.

FIG. 8B illustrates a tolerance fit between a fluted stud 148I and a clover-shaped bore 156E having a plurality of protrusions 160. Depending on the relative rotational position between the protrusions 160 and the stud 148I, the protrusions 160 may prevent the bore 156E from receiving the stud 148.

FIG. 8C illustrates an interference fit between the circular stud 148A and the bore 156F. Due to the geometry of the bore 156F, the stud 148A may be received and held within different portions of the bore 156F, thereby allowing for different configurations or alignments between the busbar 152 and the cell frame 136.

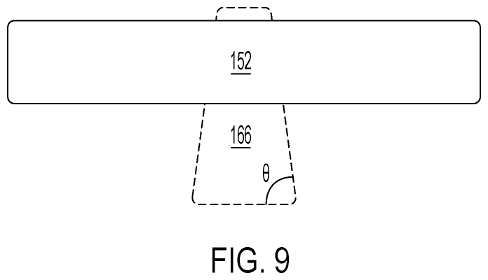

FIG. 9 is a schematic illustrating the interaction between a busbar 152 and a tapered stud 166. The busbar 152 and the stud 166 may incorporate any of the previously mentioned geometries. In the illustrated construction, the tapered stud 166 has a taper angle of less than 90 degrees. Said another way, the diameter of the tapered stud 166 increases from the top to the bottom of the tapered stud 166. In other constructions, the tapered stud 166 may have a taper angle greater than 90 degrees. In some constructions, the busbar 152 may additionally or alternatively include a taper or countersink. It will be appreciated that the inclusion of a taper or countersink in one or both of the stud 166 and busbar 152 provides more tolerance when aligning a bore of the busbar 152 with a corresponding stud of the cell frame 136, thereby reducing the precision requirements during manufacturing and/or formation of the stud 166 or bore 156 and while assembling the busbar 152 and cell frame 136 together.

In operation, during manufacturing of the battery pack 100, the busbar 152 is provisionally secured to or positioned on the cell frame 136 by inserting the stud(s) 148 through the bore(s) 156. The engagement between the stud 148 and the bore 156 holds the busbar 152 in place so that subsequent manufacturing steps may more easily be performed, such as welding or soldering the busbar 152 to the battery cells 142 or to the PCB 140, while maintaining the correct positioning and alignment of the busbar 152 relative to the cell frame 136.

Although the disclosure has been described with reference to certain preferred aspects, variations and modifications exist within the scope and spirit of one or more independent aspects of the disclosure as described.

Various features and advantages of the disclosure are set forth in the following claims.

What is claimed is:

1. A battery pack comprising:
a housing defining an internal cavity;
a cell frame disposed within the internal cavity and configured to support a plurality of battery cells, the cell frame including an exterior surface, a first stud, and a second stud extending from the exterior surface, the first stud having a first cross-sectional dimension and the second stud having a second cross-sectional dimension different from the first cross-sectional dimension; and
a busbar disposed within the internal cavity and electrically coupled to the plurality of battery cells, the busbar defining a first bore and a second bore;
wherein the first bore is configured to receive the first stud and the second bore is configured to receive the second stud.

2. The battery pack of claim 1, wherein a difference between the first cross-sectional dimension and the second cross-sectional dimension limits an orientation in which the busbar couples to the cell frame.

3. The battery pack of claim 1, wherein the first stud extends in a direction perpendicular to an axis of at least one battery cell supported by the cell frame.

4. The battery pack of claim 1, wherein the first stud is cylindrical and has a first diameter, and the second stud is cylindrical and has a second diameter larger than the first diameter.

5. The battery pack of claim 4, wherein the first bore is circular and the second bore is non-circular.

6. The battery pack of claim 5, wherein the second bore is rectangular and defines a length and a width that are each greater than the second diameter.

7. The battery pack of claim 5, wherein the second bore is rectangular and defines a length and a width, and wherein the length and width bound an inscribed circle, and wherein a diameter of the inscribed circle is smaller than the first diameter of the first stud.

8. A battery pack comprising:
a housing defining an internal cavity and an interface configured to couple to a power tool;
a cell frame disposed within the internal cavity and configured to support a plurality of battery cells, the cell frame including an external surface and a stud protruding from the external surface;
a busbar disposed within the internal cavity and electrically coupled to the plurality of battery cells, the busbar defining a bore configured to receive the stud; and
a printed circuit board disposed within the internal cavity and electrically coupled to the busbar;
wherein the stud couples the busbar to the cell frame.

9. The battery pack of claim 8, wherein the stud has a non-circular cross-section.

10. The battery pack of claim 9, wherein the non-circular cross-section is selected from a group consisting of a triangular shape, a square shape, a cross shape, or a fluted shape.

11. The battery pack of claim 8, wherein the bore has a clover-shaped cross-section and the busbar includes inwardly extending protrusions protruding into the bore.

12. The battery pack of claim 8, wherein the bore receives the stud by an interference fit.

13. The battery pack of claim 8, wherein the stud is formed from a first material and the busbar is formed from a second material that is harder than the first material.

14. The battery pack of claim 13, wherein the cell frame is formed of resin material and the busbar is formed of an electrically conductive metal.

15. A battery pack comprising:
a housing defining an internal cavity and an interface configured to couple to a power tool;
a cell frame disposed within the internal cavity and configured to support a plurality of battery cells, the cell frame including an external surface and a stud protruding from the external surface; and
a busbar disposed within the internal cavity and electrically coupled to the plurality of battery cells, the busbar defining a bore configured to receive the stud;
wherein the stud includes a tapered portion configured to guide alignment of the stud into the bore.

16. The battery pack of claim 15, wherein the bore receives the stud by an interference fit.

17. The battery pack of claim 15, wherein the stud is formed from a first material and the busbar is formed from a second material that is harder than the first material.

18. The battery pack of claim 17, wherein the cell frame is formed of resin material and the busbar is formed of an electrically conductive metal.

19. The battery pack of claim 15, wherein the stud extends in a direction perpendicular to an axis of at least one battery cell supported by the cell frame.

20. The battery pack of claim 15, wherein the bore has a non-circular cross-section.
